(19) United States
(12) Patent Application Publication
(10) Pub. No.: US 2025/0111149 A1
(43) Pub. Date: Apr. 3, 2025

(54) GENERATING AND MAINTAINING COMPOSITE ACTIONS UTILIZING LARGE LANGUAGE MODELS

(71) Applicant: Dropbox, Inc., San Francisco, CA (US)

(72) Inventors: Vasanth Krishna Namasivayam, Danville, CA (US); Devin Mancuso, San Francisco, CA (US); Geoff Hulten, Lynnwood, WA (US); Shubham Goel, San Francisco, CA (US); Sateesh Srinivasan, Redwood City, CA (US); Tony Xu, Redmond, WA (US)

(21) Appl. No.: 18/478,066

(22) Filed: Sep. 29, 2023

(51) Int. Cl. G06F 40/20; G06F 11/34

(52) U.S. Cl. CPC G06F 40/20; G06F 11/3438

(57) ABSTRACT

The present disclosure relates to systems, non-transitory computer-readable media, and methods for generating composite actions for a user account. In particular, in one or more embodiments, the disclosed systems determine a set of tasks performable by the user account using software tools on a client device. In some embodiments, the disclosed systems generate a task initialization prompt to provide to a large language model. Additionally, in some implementations, the disclosed systems generate a composite action comprising a hybridized combination of the set of tasks performable by the user account along with a set of content items relevant to the set of tasks. Moreover, in some embodiments, the disclosed systems provide access to the composite action and the set of content items via a user interface of the client device. Furthermore, in some implementations, the disclosed systems generate and insert predicted content into a content item without user input.

### BACKGROUND

Advancements in computing devices and networking technology have given rise to a variety of innovations in cloud-based digital content storage and access. For example, online digital content systems can provide access to digital content items across devices all over the world. Existing systems can also synchronize changes to shared digital content across different types of devices operating on different platforms. Indeed, modern online digital content systems can provide access to digital content for users to collaborate across diverse physical locations and over a variety of computing devices. Despite these advances, however, existing digital content systems continue to suffer from a number of disadvantages, particularly in terms of flexibility and efficiency.

As just suggested, some existing digital content systems are inflexible. In particular, many existing systems are rigidly fixed to the conventional paradigm of providing access to content items using files and folders which are navigable via interaction with client devices. For example, some existing systems provide access to stored content items via drill-down navigation within a hierarchy of folders and/or via a search function to locate a directory for a searched content item. Additionally, some existing systems are rigidly fixed to traditional delivery of tasks (e.g., a to-do list that a user creates and manages). Indeed, to provide access to tasks and related content items, existing systems can require separate computer applications (e.g., a scheduling application, a browser application, a file management application, etc.), even for accessing tasks and content items of a common topic. Beyond this, should user accounts engage in communication regarding one or more tasks or content items, many existing systems require further separate applications to facilitate such communication and editing (or other interaction).

Due at least in part to their inflexibility, many existing digital content systems are also inefficient. To elaborate, many existing systems consume excessive amounts of computer resources, such as processing power and memory, by running separate applications for accessing tasks, accessing stored content items, accessing web-based content items, and communicating between client devices. In addition, some existing systems provide inefficient user interfaces that require many navigational operations performed via client devices to access desired content and/or functionality. For example, existing systems often require many drill-down operations to navigate folders to access a content item.

Thus, there are several disadvantages with regard to existing digital content systems.

### BRIEF SUMMARY

Embodiments of the present disclosure provide benefits and/or solve one or more of the foregoing or other problems in the art with systems, non-transitory computer-readable media, and methods for generating and maintaining composite actions utilizing large language models. To illustrate, in some embodiments, the disclosed systems utilize connectors to collect user account data from a content management system and from third-party services. From the user account data, in some implementations, the disclosed systems determine tasks performable by the user account and prioritize the tasks utilizing one or more prioritization algorithms. In addition, in some implementations, the disclosed systems create a large language model prompt from the prioritized tasks and activity history of the user account. Processing the large language model prompt through a large language model, the disclosed systems can generate a composite action that includes at least some of the prioritized tasks (e.g., a set of tasks related to accomplishing a result), as well as a content stack including content items to support the composite action. Moreover, upon initialization of a composite action, the disclosed systems can maintain the composite action by receiving notifications directed to the user account and determining which notifications to surface to a user interface of a client device of the user account based on priority levels of the notifications. Furthermore, in some implementations, the disclosed systems generate update notifications including status information of the composite action, and provide the update notifications to additional user accounts of the content management system.

Additionally, in some embodiments, the disclosed systems automatically generate content to insert into a content item without user input. For example, in some implementations, the disclosed systems detect client device activity that indicates a user account's need for additional content to add to a content item. Based on the device activity, the disclosed systems can determine an input prediction for the additional content. Then, in some implementations, the disclosed systems automatically generate predicted content based on the input prediction. In other words, the disclosed systems can generate the predicted content without receiving input from the client device. Moreover, in some implementations, the disclosed systems automatically insert the predicted content into the content item. For example, the disclosed systems can insert the predicted content into the content item without user interaction. In this way, some implementations of the disclosed systems offer a “zero-click” approach to content creation, thereby assisting a user account to progress efficiently towards completion of a composite action.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates an example diagram of an environment in which a composite action system operates in accordance with one or more embodiments.

FIG. 2 illustrates the composite action system prioritizing tasks, generating a composite action, maintaining the composite action, and updating additional user accounts in accordance with one or more embodiments.

FIG. 3 illustrates the composite action system analyzing a knowledge graph and utilizing a large language model to generate a composite action and a content stack in accordance with one or more embodiments.

FIG. 4 illustrates the composite action system utilizing one or more prioritization algorithms to generate a set of prioritized tasks in accordance with one or more embodiments.

FIG. 5 illustrates the composite action system processing a set of prioritized tasks and user account activity history through a large language model to generate a composite action and a content stack in accordance with one or more embodiments.

FIG. 6 illustrates the composite action system evaluating a series of notifications utilizing a composite action shield to determine actions for each notification in accordance with one or more embodiments.

FIG. 7 illustrates the composite action system generating notifications for additional user accounts of a content management system in accordance with one or more embodiments.

FIGS. 8A and 8B illustrate the composite action system providing a composite action and a content stack for display via a user interface of a client device in accordance with one or more embodiments.

FIG. 9 illustrates the composite action system generating predicted content and inserting the predicted content into a content item without user input in accordance with one or more embodiments.

FIG. 10 illustrates the composite action system generating draft content and inserting the draft content into a template file without user input in accordance with one or more embodiments.

FIG. 11 illustrates the composite action system providing a content item for display via a user interface of a client device, populating the content item with predicted content without user input, and notifying the user account of the added content in accordance with one or more embodiments.

FIG. 12 illustrates a flowchart of a series of acts for generating and providing composite actions in accordance with one or more embodiments.

FIG. 13 illustrates a flowchart of a series of acts for generating predicted content without client device input and inserting the predicted content within a content item without user interaction in accordance with one or more embodiments.

FIG. 14 illustrates a block diagram of an example computing device for implementing one or more embodiments of the present disclosure.

FIG. 15 illustrates a network environment of a content management system in accordance with one or more embodiments.

### DETAILED DESCRIPTION

This disclosure describes one or more embodiments of a composite action system that generates and maintains composite actions utilizing large language models. To illustrate, in some embodiments, the composite action system collects user account data from a content management system and from third-party services. Utilizing the user account data, the composite action system can determine tasks of the user account (e.g., to be performed) and prioritize the tasks utilizing one or more prioritization algorithms or utilizing a large language model. In addition, in some implementations, the composite action system creates a large language model prompt from the prioritized tasks and from activity history of the user account. By processing the large language model prompt through a large language model, the composite action system can generate composite actions that includes prioritized tasks grouped by relevance to an objective. In addition, utilizing the large language model, the composite action system can generate a content stack including content items that correspond to and support the composite action.

Moreover, upon initialization of a composite action, the composite action system can maintain the composite action by intercepting notifications directed to the user account and determining which notifications to surface to a user interface of a client device of the user account. For instance, the composite action system groups the notifications into various priority categories, and determines whether to surface a notification to the user account based on the notification's priority level. Furthermore, in some implementations, the composite action system generates update content that summarizes missed notifications. The composite action system provides the update content to the user account upon completion or pause of the composite action, thereby facilitating enhanced focus on the composite action during work on the composite action.

Furthermore, the composite action system can generate update notifications for other user accounts of the content management system, thereby providing status information about a composite action. In addition, in some embodiments, the composite action system provides additional composite actions to one or more of the other user accounts that cooperate with the first composite action in a broader organizational project.

Additionally, in some embodiments, the composite action system automatically generates content to insert into a content item without user input. For example, in some implementations, the composite action system detects client device activity that indicates a user account's need for additional content to add to a content item. Based on the device activity, the composite action system can determine an input prediction for the additional content. Then, in some implementations, the composite action system automatically generates predicted content based on the input prediction. Thus, the composite action system can generate predicted content without receiving input from the client device.

Moreover, in some implementations, the composite action system automatically inserts the predicted content into the content item. For example, the composite action system can insert the predicted content into the content item without user interaction. In this way, some implementations of the composite action system offer a “zero-click” approach to content creation, thereby assisting a user account to progress efficiently towards completion of a composite action.

The composite action system provides a variety of technical advantages relative to existing digital content systems. For example, the composite action system can improve flexibility over existing systems. Indeed, while some existing systems are rigidly fixed to the traditional delivery of tasks and content items in individual windows and on express command by a user (e.g., by navigating for a content item and selecting the content item), the composite action system can provide prioritized tasks in a composite action that allows a user account to focus exclusively or primarily on the tasks of the composite action and supporting content items. Moreover, the composite action system can generate a content stack relevant to the composite action and provide the content stack (i.e., with content items) directly in the same interface as the tasks of the composite action. Furthermore, the composite action system can increase flexibility by generating content items for a user account that summarizes missed information (e.g., suppressed notifications during work within a composite action), update other user accounts with status indicia for the composite action, and/or automatically populate a content item with content by predicting relevant content that the user account would otherwise manually locate or generate and add to the content item.

Due at least in part to its improved flexibility, the composite action system can also improve efficiency over existing digital content systems. For example, in contrast with prior systems that consume excessive amounts of computer resources (such as processing power, storage space, and memory) by running separate applications for accessing tasks, accessing stored content items, accessing web-based content items, and communicating between client devices, the composite action system can condense many functions into a single application and a single interface. For example, the composite action system can embed multiple external applications directly within a single user interface, thereby reducing the navigational burden of prior systems that require many navigational operations across different interfaces and applications. In addition, the composite action system reduces the number of drill-down operations to access a content item by providing content stacks for directly accessing relevant content items (e.g., with a single click or a single text query). Consequently, the composite action system not only improves navigational efficiency but also improves computational efficiency by reducing the computing resources required to run many different applications at once.

Moreover, the composite action system can improve the efficiency of computer storage usage. In particular, the composite action system can provide content stacks as a set of links to content items, which allows a user to interact with the content items in a content stack as if they were stored together, when the actual content items may be stored in various locations within a content management system (e.g., various different folders). Because the composite action system provides content stacks as sets of links, the composite action system can provide a seamless user experience while it also reduces or minimizes computer storage needed for content items because only a single copy of a particular content item is needed to be stored to allow the composite action system to include a link to the particular content item within multiple different content stacks (as opposed to creating multiple different copies of the same content item to store in multiple different folders).

As illustrated by the foregoing discussion, the present disclosure utilizes a variety of terms to describe features and advantages of the composite action system. Additional detail is hereafter provided regarding the meaning of these terms as used in this disclosure. For example, as used herein, the term “digital content item” (or “content item”) refers to a digital object or a digital file that includes information interpretable by a computing device (e.g., a client device) to present information to a user. A content item can include a file or a folder such as a digital text file, a digital image file, a digital audio file, a webpage, a website, a digital video file, a web file, a link, a hyperlinked video file streamable from a webpage, a calendar event, a task, a to-do list, a contact card, a text message thread, a direct message thread, a chat group thread, a social media feed, a social media post, a news article, a headline, a technical support ticket, a digital document file, or some other type of file or digital object. A content item can have a particular file type or file format, which may differ for different types of content items (e.g., digital documents, digital images, digital videos, or digital audio files, etc.). In some cases, a content item can refer to a remotely stored (e.g., cloud-based) item or a link (e.g., a link or reference to a cloud-based content item or a web-based content item). A content item can include a content clip that indicates, links, and/or references a discrete selection or segmented sub-portion of content from a larger content item. For example, a content item can be a clipped portion of a webpage, audio recording transcript, videoconference recording transcript, or other content item or source. A content item can be editable or otherwise modifiable and can also be sharable from one user account (or client device) to another. In some cases, a content item is modifiable by multiple user accounts (or client devices) simultaneously and/or at different times. Additionally, a content item can include metadata associated with another content item.

As a subset of content items, a “web content item” or a “web-based content item” refers to a content item accessible via the Internet, such a webpage, a website, or a cloud-based content item not accessed locally. For example, a web content item can refer to an internet-based content item, such as a content item identified by, or located at, a URL address. A web content item can include a content item coded or defined by HTML, JavaScript, or another internet language. In some cases, a web content item can include a content item accessible via HTTP(S) protocol (or some other internet protocol) via a web browser.

As used herein, the term “machine learning model” refers to a computer representation that is tunable (e.g., trained) based on inputs to approximate unknown functions used for generating corresponding outputs. In particular, a machine learning model can include a computer-implemented model that utilizes algorithms to learn from, and make predictions on, known data by analyzing the known data to learn to generate outputs that reflect patterns and attributes of the known data. For instance, a machine learning model can include, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof. In some embodiments, the composite action system utilizes a large language machine learning model in the form of a neural network.

Similarly, as used herein, the term “neural network” refers to a machine learning model that can be trained and/or tuned based on inputs to determine classifications and/or scores, or to approximate unknown functions. For example, a neural network can include a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a diffusion neural network, a recurrent neural network (e.g., an LSTM), a graph neural network, a transformer, or a generative adversarial neural network. Upon training, a neural network may become a large language model.

Relatedly, as used herein, the term “large language model” refers to a machine learning model trained to perform computer tasks to generate or identify content items in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify content items based on various contextual data, including information from a knowledge graph, an index, and/or historical user account behavior.

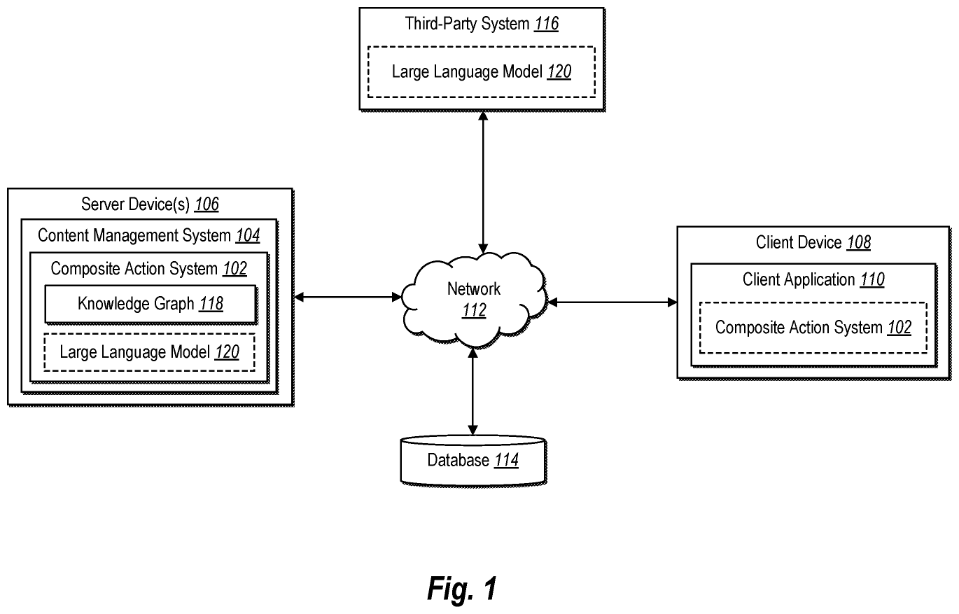

Additional detail regarding the composite action system will now be provided with reference to the figures. For example, FIG. 1 illustrates a schematic diagram of an example system environment for implementing a composite action system 102 in accordance with one or more implementations. An overview of the composite action system 102 is described in relation to FIG. 1. Thereafter, a more detailed description of the components and processes of the composite action system 102 is provided in relation to the subsequent figures.

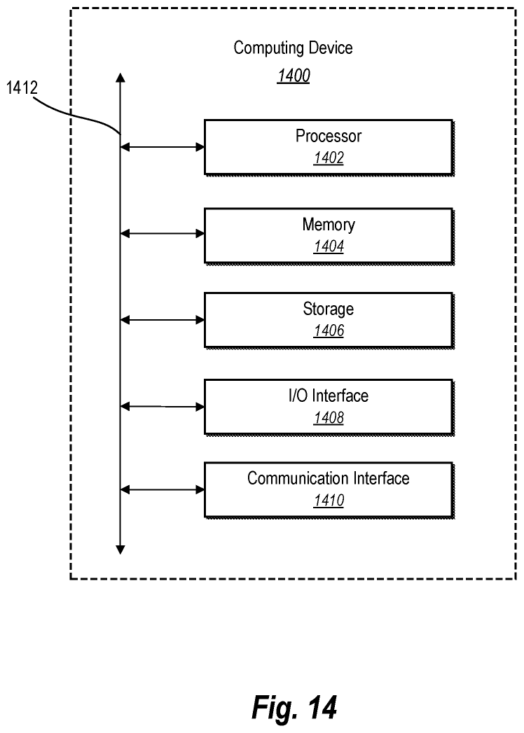

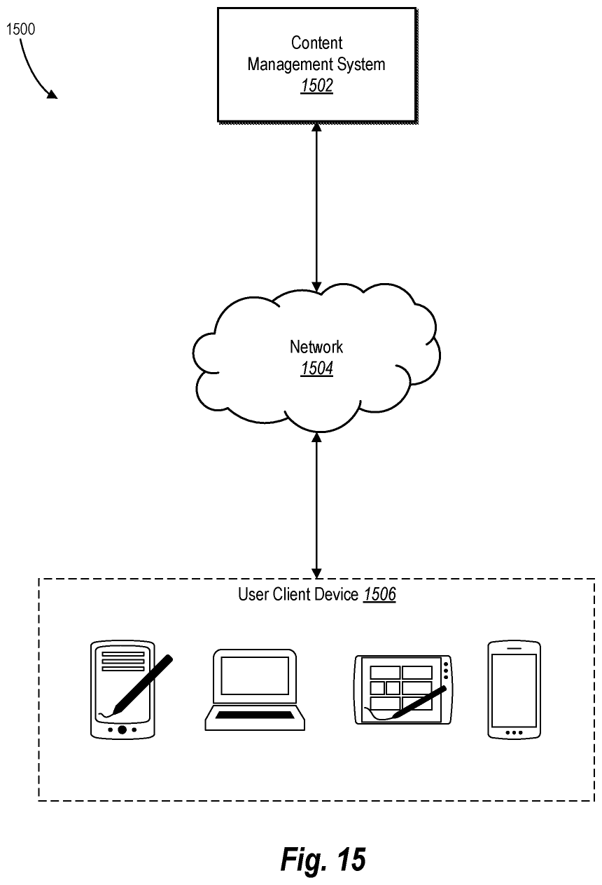

As shown, the environment includes server device(s) 106, a client device 108, a database 114, a third-party system 116, and a network 112. Each of the components of the environment can communicate via the network 112, and the network 112 may be any suitable network over which computing devices can communicate. Example networks are discussed in more detail below in relation to FIGS. 14-15.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIGS. 14-15. The client device 108 can communicate with the server device(s) 106, the third-party system 116, and/or the database 114 via the network 112. For example, the client device 108 can receive user input from a user interacting with the client device 108 (e.g., via a client application 110) to, for instance, access, generate, modify, and/or share one or more content items, to collaborate with a co-user of a different client device, or to select a user interface element. In addition, the composite action system 102 on the server device(s) 106 can receive information relating to various interactions with content items and/or user interface elements based on the input received by the client device 108 (e.g., to initialize and/or maintain a composite action, access content items, interact with content stacks, or perform some other action).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server device(s) 106. Based on instructions from the client application 110, the client device 108 can present or display information, including an interface for presenting content items (e.g., via embedded applications) from a content management system 104 or from other network locations.

As illustrated in FIG. 1, the example environment also includes the server device(s) 106. The server device(s) 106 may generate, track, store, process, receive, and/or transmit electronic data, such as digital content items, interface elements, interactions with digital content items, interactions with interface elements, and/or interactions between user accounts or client devices. For example, the server device(s) 106 may receive data from the client device 108 in the form of a composite action prompt to generate a composite action, generate or retrieve a particular content item, and/or perform some other act in support of the composite action. In addition, the server device(s) 106 can transmit data to the client device 108 in the form of an interface that includes one or more composite actions and/or one or more content items related to a composite action. Indeed, the server device(s) 106 can communicate with the client device 108 to send and/or receive data via the network 112. In some implementations, the server device(s) 106 comprises a distributed server where the server device(s) 106 includes a number of server devices distributed across the network 112 and located in different physical locations. The server device(s) 106 can comprise one or more content servers, application servers, communication servers, web-hosting servers, machine learning servers, and/or other types of servers.

As shown in FIG. 1, the server device(s) 106 can also include the composite action system 102 as part of a content management system 104. The content management system 104 can communicate with the client device 108 to perform various functions associated with the client application 110 such as managing user accounts, managing content collections, managing content items, and facilitating user interaction with the content collections and/or content items. Indeed, the content management system 104 can include a network-based smart cloud storage system to manage, store, and maintain content items and related data across numerous user accounts, including user accounts in collaboration with one another. In some embodiments, the composite action system 102 and/or the content management system 104 utilize the database 114 to store and access information such as digital content items.

As also illustrated in FIG. 1, the composite action system 102 can include a knowledge graph 118 and a large language model 120. In particular, the composite action system 102 can utilize the large language model 120 that is integrated with (e.g., trained by data from) the content management system 104 and/or the knowledge graph 118. For example, the knowledge graph 118 can store or encode relationship information to define relationships between user accounts and content items within the content management system 104 (and/or housed at other server locations). From the knowledge graph 118, the large language model 120 can generate or identify composite actions and content items to provide to the client device 108 in response to a user interaction via an interface. For instance, the large language model 120 can utilize the knowledge graph 118 to generate a composite action for a user account based on a composite action prompt received from the client device 108.

FIG. 1 further illustrates a third-party system 116. In particular, the third-party system 116 can host or house the large language model 120 (e.g., as an alternative to the server device(s) 106 hosting or housing the large language model 120) for access by the composite action system 102. For example, the third-party system 116 can include a server location hosting the large language model 120 that is external to the composite action system 102. In some cases, the third-party system 116 is external to the composite action system 102, but the composite action system 102 can nevertheless access and utilize the large language model 120 to generate or identify composite actions and content items by analyzing the knowledge graph 118 on the server device(s) 106.

Although FIG. 1 depicts the composite action system 102 located on the server device(s) 106, in some implementations, the composite action system 102 may be implemented by (e.g., located entirely, or in part, on) one or more other components of the environment. For example, the composite action system 102 may be implemented by the client device 108, and/or a third-party device. For example, the client device 108 can download all or part of the composite action system 102 for implementation independent of, or together with, the server device(s) 106.

In some implementations, the environment may have a different arrangement of components and/or may have a different number or set of components altogether. For example, the client device 108 may communicate directly with the composite action system 102 on the server device(s) 106, bypassing the network 112. As another example, the environment can include the database 114 located external to the server device(s) 106 (e.g., in communication via the network 112) or located on the server device(s) 106, on the third-party system 116, and/or on the client device 108.

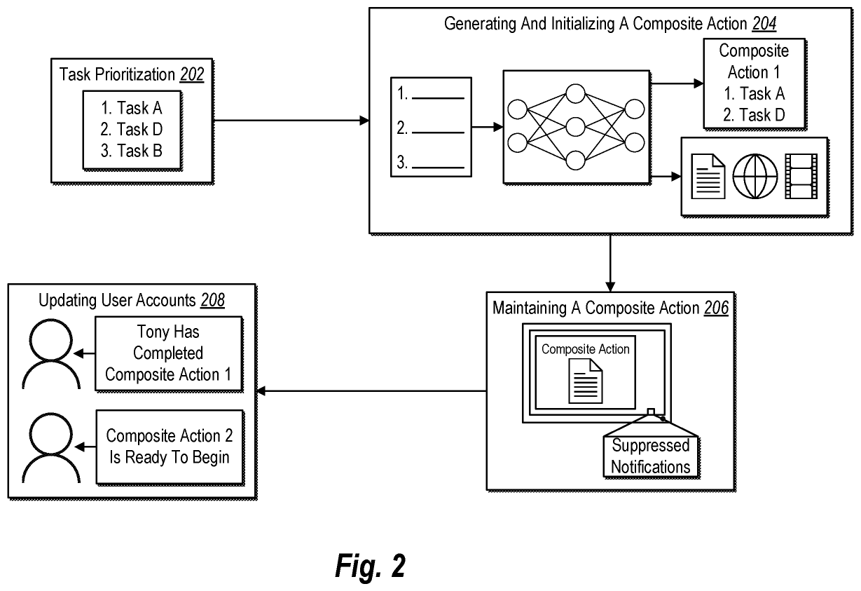

As discussed, in some implementations, the composite action system 102 performs actions to assist a user account in performing tasks. For instance, FIG. 2 illustrates the composite action system 102 prioritizing tasks, generating a composite action, maintaining the composite action, and updating additional user accounts in accordance with one or more embodiments.

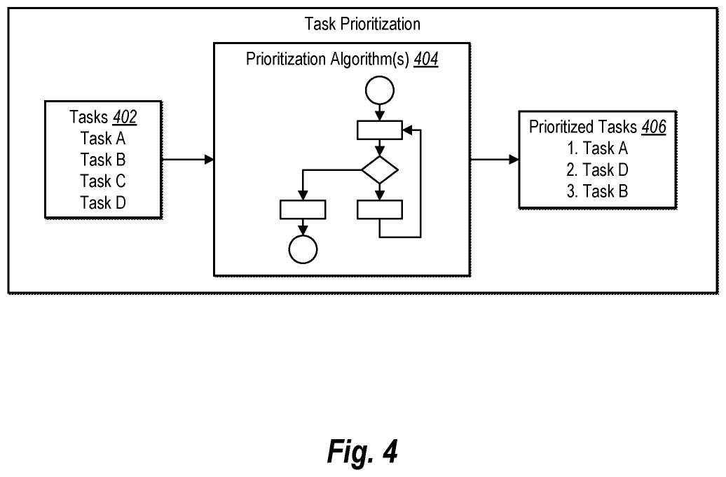

To illustrate, and as described in additional detail below in connection with FIG. 4, the composite action system 102 performs an act 202 for prioritizing tasks. For instance, the composite action system 102 receives a plurality of tasks performable by the user account. Utilizing one or more prioritization algorithms, the composite action system 102 determines priorities of each of the plurality of tasks. In this way, the composite action system 102 can generate a list of prioritized tasks for the user account.

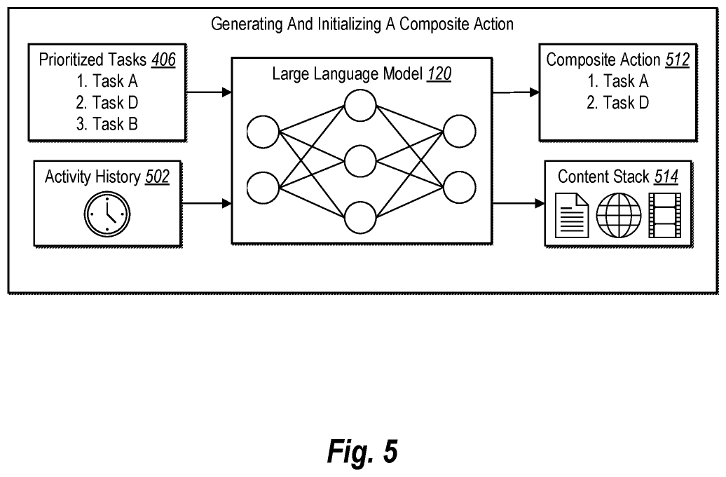

Upon prioritizing the tasks, the composite action system 102 can perform an act 204 for generating and initializing a composite action. As explained further below in connection with FIG. 5, the composite action system 102 can utilize the list of prioritized tasks to generate a large language model prompt (e.g., a task initialization prompt). In some embodiments, the composite action system 102 includes activity history of the user account in the large language model prompt. With the large language model prompt, the composite action system 102 utilizes a large language model to generate a composite action that includes a hybridized combination of tasks. For example, the composite action system 102 may determine that certain tasks from the prioritized list of tasks relate to an objective of the user account, and may include those certain tasks in the composite action. In addition, the composite action system 102 can generate a content stack with content items relevant to the hybridized combination of tasks, and can provide the content stack to the user account (e.g., with the composite action) via a user interface.

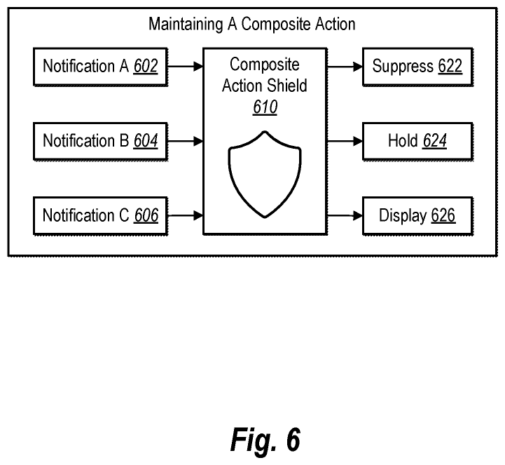

Moreover, the composite action system 102 can perform an act 206 for maintaining a composite action, as further detailed below in connection with FIG. 6. To illustrate, the composite action system 102 provides (e.g., to a client device of the user account) a user interface layout that can maximize (or increase) focus on the composite action and minimize (or decrease) display of user interface elements (e.g., notifications) that may potentially be distracting. For instance, the composite action system 102 can suppress notifications that do not relate to the tasks within the composite action. Furthermore, the composite action system 102 can aggregate the suppressed notifications and provide a summary of them for display after the user account completes or pauses the composite action.

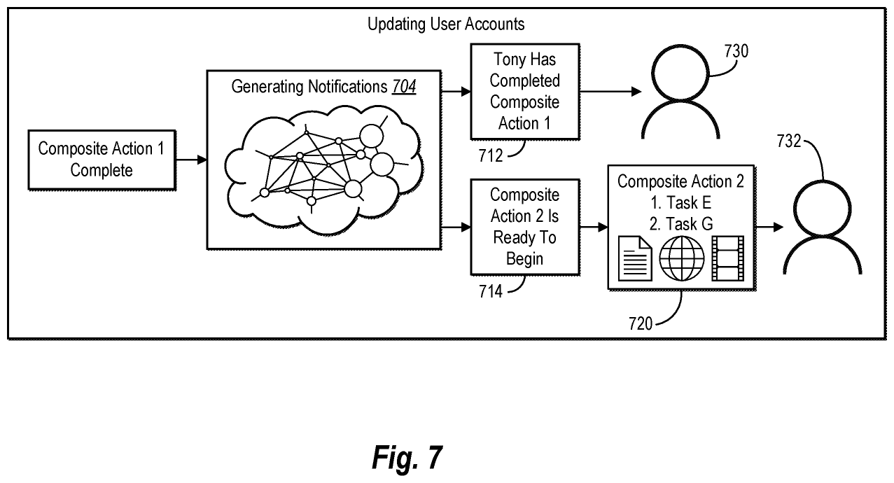

Additionally, in some implementations, the composite action system 102 performs an act 208 for updating user accounts. As discussed further below in connection with FIG. 7, the composite action system 102 can generate notifications for additional user accounts of the content management system (e.g., user accounts closely related to the user account within an organizational ontology). For instance, the composite action system 102 generates a notification that indicates that the user account has completed the composite action. As another example, the composite action system 102 generates a notification indicating that another composite action is ready to begin (e.g., by another user account, and as a result of the user account completing the composite action).

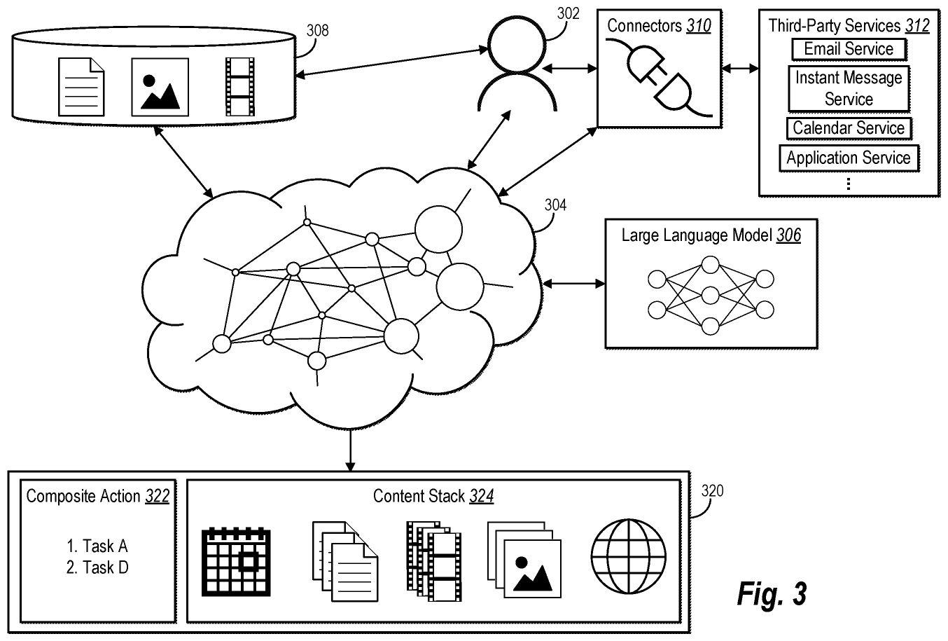

As discussed, in some embodiments, the composite action system 102 generates and provides a composite action and a content stack to a user account. For instance, FIG. 3 illustrates the composite action system 102 analyzing a knowledge graph and utilizing a large language model to generate a composite action and a content stack in accordance with one or more embodiments.

Specifically, FIG. 3 shows the composite action system 102 identifying a user account 302. In some embodiments, the composite action system 102 determines account profile data and/or account activity data (including activity history data) of the user account 302. For example, the composite action system 102 can identify activity data such as web browser history, file accesses, calendar information, and communications (e.g., email, text message, group chat) with other user accounts to determine current interests, tasks, workflows, projects, and/or data needs of the user account 302. As described in additional detail below, the composite action system 102 can utilize the account profile data and/or account activity data to determine data needs for the user account 302.

As mentioned, in some implementations, the composite action system 102 generates and/or utilizes a knowledge graph to define relationships between content items and user accounts. For example, in some embodiments, the composite action system 102 generates an account-specific knowledge graph 304 (e.g., specific to the user account 302) comprising nodes and edges. In some implementations, the knowledge graph 304 is the same as or similar to the knowledge graph 118. To illustrate, the composite action system 102 identifies a body of content items (e.g., including all content items in the content management system 104, or including a subset of content items in the content management system 104 that are close to the user account 302 in a larger knowledge graph) and a group of user accounts associated with the user account 302. For each content item associated with the user account 302, the composite action system 102 generates a node that represents the content item. Additionally, for each user account associated with the user account 302, the composite action system 102 generates a node that represents the user account.

To further illustrate, in some implementations, the composite action system 102 connects the nodes of the knowledge graph 304 with edges (e.g., a connecting line between two nodes) that each represent a relationship between two content items, between two user accounts, or between a content item and a user account. Typically, an edge with a short length indicates a close relationship between nodes. For example, a short edge length between two nodes can indicate that two content items (represented by the nodes) are similar or otherwise related (e.g., authored by the same user account, viewed by the same user account, stored in a common folder, etc.). As another example, a short edge length between two nodes can indicate that two user accounts (represented by the nodes) frequently communicate with each other and/or are similarly situated in an organizational ontology. Still another example, a short edge length between two nodes can indicate that a content item (represented by one node) has been created by, modified by, shared by, accessed by, and/or is likely to be accessed by a user account (represented by the other node).

For example, the knowledge graph 304 includes account-based signals and content-based signals that indicate the relationships between the user accounts and the content items. The composite action system 102 can utilize the account-based signals and/or the content-based signals to develop large language model prompts for generating composite actions.

As mentioned, in some embodiments, the composite action system 102 utilizes a large language model to analyze the relationships defined in a knowledge graph. For instance, the composite action system 102 utilizes a large language model 306 (e.g., similar to or the same as large language model 120) to determine a subset of nodes of the knowledge graph 304 that are relevant to a large language model prompt. For example, the composite action system 102 can utilize the large language model 306 to generate embedded representations of content items in a latent feature vector space representing various task topics and/or content topics. Furthermore, the composite action system 102 can utilize the large language model 306 to group tasks and content items according to topic features to facilitate accurate composite action suggestions and content stacks based on the large language model prompts.

As also mentioned, in some implementations, the composite action system 102 accesses a database (e.g., the database 114, data storage on the server device(s) 106, data storage on the client device 108, etc.) containing content items. For example, the composite action system 102 accesses database 308 to identify, retrieve, and/or store content items relevant to a large language model prompt corresponding with the user account 302. In some embodiments, the composite action system 102 accesses multiple databases to identify, retrieve, and/or store content items. In some cases, the composite action system 102 generates new content items and adds the new content items to the database 308. Additionally, as noted above, the composite action system 102 can access web-based content items through the Internet.

Furthermore, in some embodiments, the composite action system 102 utilizes connectors 310 to collect data from software tools used by the user account. Connectors include computing applications that retrieve information (e.g., usage metrics, communication metrics, etc.) from user-account-facing applications. For instance, the composite action system 102 utilizes the connectors 310 to collect data from third-party services 312, such as communication applications (e.g., email services, instant messaging services, text messaging services, videoconferencing services), calendar applications, and/or other application services (e.g., project management applications). To illustrate, the composite action system 102 collects, via the connectors 310, data reflecting usage by the user account 302 of the third-party services 312.

To further illustrate, the composite action system 102 can utilize the connectors 310 to collect the data from the third-party services 312 and determine a set of tasks performable by the user account 302 using the third-party services 312. Moreover, the composite action system 102 can utilize the connectors 310 to collect audio data (e.g., from a videoconference recording associated with the user account 302), text data (e.g., from written communications associated with the user account 302), schedule data (e.g., from a calendar associated with the user account 302), project data (e.g., from a project management application associated with the user account 302), and/or other data (e.g., from other third-party services that interface with the user account 302).

As discussed above and in further detail below, in some implementations, the composite action system 102 utilizes the large language model 306 to generate digital assistant deliverables 320 for the user account 302. In particular, the composite action system 102 generates one or more composite actions to provide to the user account 302. For example, the composite action system 102 generates a composite action 322. The composite action 322 can include a hybridized combination of tasks. For example, the composite action system 102 can present the tasks within the composite action 322 based on their priorities and/or their relevance to a current objective of the user account 302. To illustrate, the composite action system 102 identifies nodes in the knowledge graph 304 that are closely related to a large language model prompt for the user account 302. For instance, the composite action system 102 identifies clusters of prioritized tasks performable by the user account 302 based on edge lengths of the edges of the knowledge graph 304.

To further illustrate, the composite action system 102 identifies the large language model prompt based on prioritized tasks of the user account 302, user inputs from the user account 302, and/or historical activity of the user account 302. In some cases, the composite action system 102 locates a set of nodes in the knowledge graph 304 that have features close to a feature representation of the large language model prompt. Upon identifying the set of nodes, the composite action system 102 presents a set of tasks corresponding to the set of nodes to the user account 302 in the form of the composite action 322.

Additionally, in some embodiments, the composite action system 102 generates one or more content stacks to provide to the user account 302. For instance, the composite action system 102 generates a content stack 324. As illustrated in FIG. 3, the content stack 324 can include several content items of a variety of content types, such as calendar items, digital documents, digital videos, digital images, webpages, and/or other content item types. To illustrate, the composite action system 102 identifies the nodes in the knowledge graph 304 that are closely related to the large language model prompt for the user account 302. Upon identifying the set of nodes, the composite action system 102 presents a set of content items corresponding to the set of nodes to the user account 302 in the form of the content stack 324.

To illustrate further, in some implementations, the composite action system 102 utilizes the large language model 306 to generate the composite action 322 and/or the content stack 324 by determining topic features for some (or all) of the content items represented by the knowledge graph 304, and identifying relevant tasks and/or content items to include in the composite action 322 and the content stack 324 based on the topic features. For example, the composite action system 102 utilizes the large language model 306 to convert the content items into a feature space indicating topics of the content items (e.g., subjects that the content items relate to, based on their content). As discussed below, in some embodiments, the composite action system 102 identifies a large language model prompt for the user account 302 (e.g., based on prioritized tasks and current or recent user account activity). The composite action system 102 compares the topic features of the content items with the large language model prompt for the user account 302 to determine a set of tasks to include in the composite action 322 and a set of content items to include in the content stack 324.

In some embodiments, the composite action system 102 generates an index of content items and user accounts. For instance, the composite action system 102 converts the knowledge graph 304 into an index comprising tables of information associated with the nodes of the knowledge graph 304. For example, the composite action system 102 generates the index with rows representing content items (including tasks) and/or user accounts, and columns representing various properties of the content items and user accounts. In some cases, the composite action system 102 utilizes the index (e.g., as an alternative to utilizing the knowledge graph) to generate large language model prompts and analyze relationships between content items and/or user accounts.

For example, in some implementations, the composite action system 102 generates the index mapped from the knowledge graph 304 of user accounts and content items of the content management system 104. The composite action system 102 determines content items relevant to a set of tasks based on relationships, shown in the index, between the set of tasks and a plurality of content items within the content management system 104.

As discussed, in some implementations, the composite action system 102 prioritizes tasks for a user account. For instance, FIG. 4 illustrates the composite action system 102 utilizing one or more prioritization algorithms to generate a set of prioritized tasks in accordance with one or more embodiments.

In particular, FIG. 4 shows the composite action system 102 obtaining a set of tasks 402 and processing the set of tasks 402 through prioritization algorithm(s) 404 to generate a set of prioritized tasks 406. In some embodiments, the composite action system 102 utilizes a knowledge graph or index to provide user account context for the prioritization based on user account actions, focuses, topics, etc. Moreover, in some embodiments, the composite action system 102 utilizes connectors to collect data for the user account from various sources, such as audio recordings, written communications, project schedules, and the like.

The composite action system 102 can use a variety of prioritization algorithm(s) 404. For example, the composite action system 102 determines, for each task within the set of tasks 402, a hierarchy of requesting user accounts of the content management system. For instance, the composite action system 102 gives the most weight to tasks that are requested or assigned by a requesting user account at a highest level (relative to other user accounts requesting or assigning tasks) within an organizational ontology of the recipient user account.

As another example, the composite action system 102 determines due dates associated with each task within the set of tasks 402. For instance, the composite action system 102 gives the most weight to tasks that have the earliest (i.e., closest) due dates.

As yet another example, the composite action system 102 determines, based on signals of a knowledge graph associated with the set of tasks 402, an importance metric for each task within the set of tasks 402. For instance, the composite action system 102 gives the most weight to tasks that have importance indicators (e.g., urgency, magnitude of scope, etc.). The composite action system 102 can determine the importance metrics based on signals from the knowledge graph, such as the types and/or numbers of communications about the task from certain user accounts.

As another example, the composite action system 102 determines a task creation date for each task within the set of tasks 402. For instance, in some cases, the composite action system 102 gives the most weight to tasks that have existed the longest (i.e., first created). Alternatively, in some cases, the composite action system 102 gives the most weight to tasks that are the newest (e.g., most recently created).

Furthermore, in some embodiments, the composite action system 102 prioritizes tasks for a user account jointly with other user accounts. For instance, the composite action system 102 may place a task of a first user account on hold while another task of a second user account is in progress. For example, the first and second user accounts collaborate on a multi-account project, and the composite action system 102 prioritizes tasks across accounts based on coordinated milestones within the multi-account project.

In some cases, the composite action system 102 provides an option to the user account(s) to override the task prioritizations and set task priorities manually.

In some embodiments, the composite action system 102 prioritizes the tasks 402 utilizing a machine learning model (e.g., alternatively to utilizing the prioritization algorithm(s) 404. For example, the composite action system 102 trains a large language model (e.g., the large language model 120) with training datasets comprising historical data of prioritized tasks for historical composite actions. Thus, in some implementations, the composite action system 102 can tune numerous parameters of the large language model to identify patterns in the historical data and make predictions of prioritizations for the group of tasks 402. In some embodiments, the composite action system 102 tunes the parameters of the large language model to minimize or reduce a loss function based on predictions of the large language model made during training and ground truth task prioritizations. By utilizing the large language model for task prioritization, in some cases, the composite action system 102 can scale the systems and methods disclosed herein to serve a large number of user accounts and a large amount of user account data.

As discussed, in some embodiments, the composite action system 102 generates and initializes a composite action for a user account. For instance, FIG. 5 illustrates the composite action system 102 processing a set of prioritized tasks and user account activity history through a large language model to generate a composite action and a content stack in accordance with one or more embodiments.

Specifically, FIG. 5 shows the composite action system 102 processing the set of prioritized tasks 406 and activity history 502 through the large language model 120. For example, the composite action system 102 generates, from the set of prioritized tasks 406, a task initialization prompt to provide to the large language model 120. In some embodiments, the composite action system 102 includes the activity history 502 in the task initialization prompt. Moreover, in some implementations, the composite action system 102 generates the task initialization prompt by comparing the set of prioritized tasks 406 with related tasks performable by additional user accounts. For instance, the composite action system 102 utilizes the knowledge graph to identify related tasks of other user accounts that are similar to the prioritized tasks 406, and generates the task initialization prompt based on the related tasks.

As discussed in connection with FIG. 3, in some embodiments, the composite action system 102 utilizes the large language model 120 to generate a composite action 512. In addition, in some implementations, the composite action system 102 utilizes the large language model 120 to generate a content stack 514. For example, the composite action system 102 generates, utilizing the large language model 120 to process the task initialization prompt, the composite action 512 comprising a hybridized combination of the set of tasks performable by the user account along with the set of content items (e.g., the content stack 514) relevant to the set of tasks. To illustrate, the composite action system 102 provides the content stack 514 as a ranked list of content items generated from and relevant to the task initialization prompt (or relevant to accomplishing the tasks of the composite action 512).

In some implementations, the composite action system 102 generates a stack of composite actions to provide to the user account. For example, the composite action system 102 determines a plurality of composite actions and presents the plurality of composite actions as a stack. In some implementations, the composite action system 102 provides the user account with a selectable option to begin a composite action (e.g., focus on the set of prioritized tasks within the composite action), to delay beginning the composite action (e.g., snooze to a later time), or to remove the composite action from the stack (e.g., ignore the composite action).

In some embodiments, the composite action system 102 generates an explanation or summary of the tasks within a composite action. For instance, the composite action system 102 processes the composite action (or the list of tasks within the composite action) through the large language model with a request to summarize the composite action. The composite action system 102 can include the results as a summary of the composite action. For example, the composite action system 102 provides the summary with indication of the composite action for display via the client device. To illustrate, in some cases, the composite action system 102 groups or clusters the prioritized tasks 406 according to relevance/correlation one to another (e.g., based on the knowledge graph or the index) and generates high-order objectives (e.g., the composite action 512) from the task groups/clusters, and then uses the high-order objectives to generate the summary for guiding the user account to accomplish the tasks in the corresponding group/cluster.

In some embodiments, the composite action system 102 buckets composite actions into one of two buckets: new composite actions and continued composite actions. For new composite actions, the composite action system 102 can provide content items (e.g., in the content stack 514) to help generate a first draft of a work product. For example, as detailed further below, the composite action system 102 can automatically generate new content items relevant to the composite action. For continued composite actions, the composite action system 102 provides content (e.g., a refresher or summary) to help bring the user account up to speed and continue where work previously was left off (e.g., by the user account or by a collaborating user account).

As discussed, in some implementations, the composite action system 102 maintains a composite action for a user account. For instance, FIG. 6 illustrates the composite action system 102 evaluating a series of notifications utilizing a composite action shield to determine actions for each notification in accordance with one or more embodiments.

In particular, FIG. 6 shows the composite action system 102 receiving various notifications 602-606 intended for the user account. In some cases, the various notifications 602-606 come from various collaborating user accounts and/or have various levels of importance. In some implementations, the composite action system 102 determines a priority level for each of the notifications 602-606. For instance, FIG. 6 shows the composite action system 102 utilizing a composite action shield 610 to assess the notifications 602-606 and determine their respective levels of importance. As illustrated, FIG. 6 shows the composite action system 102 selecting various actions 622-626 for the respective notifications 602-606. In particular, the composite action system 102 determines to suppress notification A 602, to hold notification B 604, and to display notification C 606.

To illustrate, in some implementations, the composite action system 102 employs an objective to minimize or reduce user interface elements that are not relevant to a current composite action of the user account. Thus, in some cases, the composite action suppresses notifications that are associated with tasks not in the composite action. For example, the composite action system 102 provides a composite action (e.g., along with relevant content items) for display via a user device. In furtherance of keeping the user account focused on the composite action, the composite action system 102 can suppress or hold notifications that would tend to divert attention of the user account. In particular, the composite action system 102 can determine that the priority level for a notification falls below a predetermined threshold priority, and therefore suppresses or holds the notification.

Moreover, in some embodiments, the composite action system 102 receives a user interface element associated with a different content item (or composite action) than a content item (or composite action) that the user account is currently working on. The composite action system 102 can determine that the user interface element is unrelated to the content item (or composite action). In consequence, the composite action system 102 can suppress the user interface element from display via the client device.

In some cases, the composite action system 102 determines that a user interface element merits immediate display to the user account. For example, the composite action system 102 determines that a notification has a high priority level. In some cases, the composite action system 102 determines that the priority level exceeds the predetermined threshold priority. Thus, the composite action system 102 provides the notification for display via a user interface of a client device of the user account.

To illustrate, in some embodiments, the composite action system 102 groups user interface elements (e.g., notifications) into one of three buckets: notifications that need to be presented/addressed immediately; notifications for tasks or other information that are informative for the user account but not urgent; and notifications for tasks or other information that are not specifically intended for the user account, but for other user accounts adjacent to the user account within the organizational ontology. Based on how the composite action system 102 groups a user interface element, the composite action system 102 can issue a corresponding action. For example, based on the respective buckets, the composite action system 102 can provide a notification for display (e.g., immediately), hold the notification for later (e.g., when the user account completes or pauses the composite action), or suppress the notification (e.g., delete and/or not provide the notification for display).

In some embodiments, the composite action system 102 generates a summary of one or more notifications that are grouped to hold for later and/or grouped to suppress. Thus, the composite action system 102 can efficiently update the user account-after the user account works on a composite action—about notifications missed during the work on the composite action. To illustrate, the composite action system 102 determines that the composite action of the user account is paused or complete. In some embodiments, the composite action system 102 generates and provides a summary content item (e.g., a widget or a summary notification) comprising a summary of the user interface elements that were not provided for display during the work on the composite action. In some embodiments, the composite action system 102 generates and provides the summary content item as an audio summary (e.g., in an audio file), thereby enabling the user account to review the summary of missed notifications as a podcast or other audio deliverable.

In some cases, the composite action system 102 tracks a context signal from the user account (e.g., based on the knowledge graph or the index) that indicates a current working context of the user account in relation to various content items. For example, the composite action system 102 determines how to group and summarize notifications based on context signals from the knowledge graph.

In addition, the composite action system 102 can provide critical analysis of a work product to help improve the work product. For example, the composite action system 102 generates a large language model prompt including the work product, and processes the large language model prompt through the large language model 120 to generate critical feedback. Moreover, the composite action system 102 can identify other user accounts (e.g., via the knowledge graph) to review and/or approve the work product.

As discussed, in some embodiments, the composite action system 102 updates user accounts with a status of a composite action. For instance, FIG. 7 illustrates the composite action system 102 generating notifications for additional user accounts of the content management system in accordance with one or more embodiments.

To illustrate, in some implementations, the composite action system 102 performs an act 704 of generating notifications based on an indication that a composite action is complete. Alternatively, in some implementations, the composite action system 102 generates notifications based on an indication that the composite action is paused, in progress, or some other status. In some embodiments, the composite action system 102 provides the notifications to the additional user accounts. For example, the composite action system 102 utilizes a knowledge graph or index to determine that collaborating user accounts should be informed of the completion status.

For example, FIG. 7 illustrates the composite action system 102 generating a notification 712 indicating that a composite action is complete. The composite action system 102 provides the notification 712 for display to a user account 730. For instance, the user account 730 may be a user account within a reporting chain above the user account completing the composite action. In addition, FIG. 7 illustrates the composite action system 102 generating a notification 714 indicating that a second composite action is ready to begin. The composite action system 102 provides the notification 714 to a user account 732. For instance, the user account 732 may be a collaborating user account with the user account completing the first composite action. By way of example, the beginning of the second composite action may depend on the completion of the first composite action. Thus, the composite action system 102 can provide the notification 714 to the user account 732 informing the user account 732 of the progression through a project including the first and second composite actions.

Moreover, FIG. 7 illustrates the composite action system 102 generating a second composite action 720 for the user account 732. For example, and as described above, the composite action system 102 utilizes the large language model 120 to generate the second composite action 720 based on a set of tasks performable by the user account 732. In addition, the composite action system 102 can provide, with the second composite action 720, content items (e.g., in a content stack) that relate to completing the second composite action 720.

In some embodiments, the composite action system 102 provides a selection option to the user account (completing or working on the first composite action) to publish the update notification(s) to client devices of the additional user accounts. For example, the composite action system 102 provides for display a view of the update notification(s) to the first user account, and gives the option to send the notification(s) to the additional user accounts. Alternatively, in some embodiments, the composite action system 102 provides the update notification(s) to the additional user accounts for display, without additional interaction by the first user account.

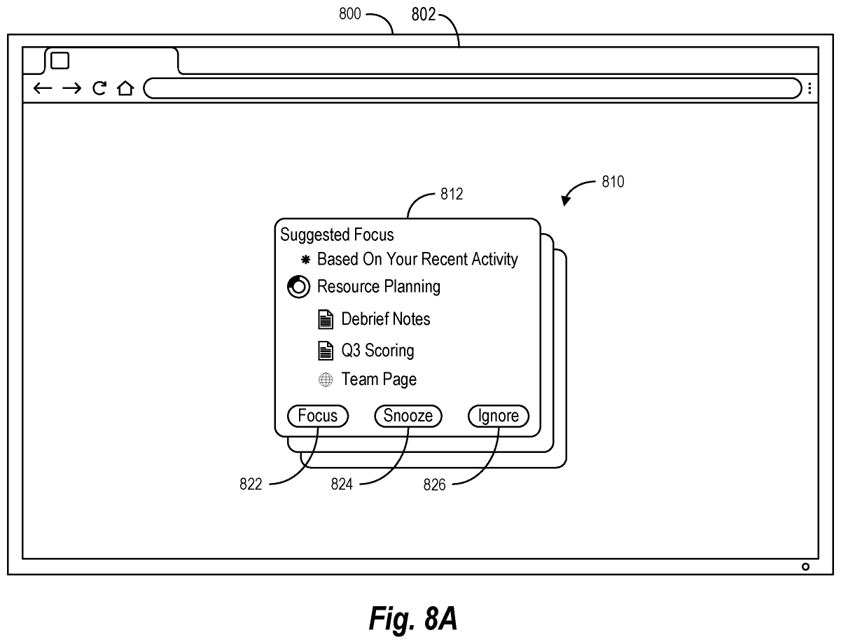

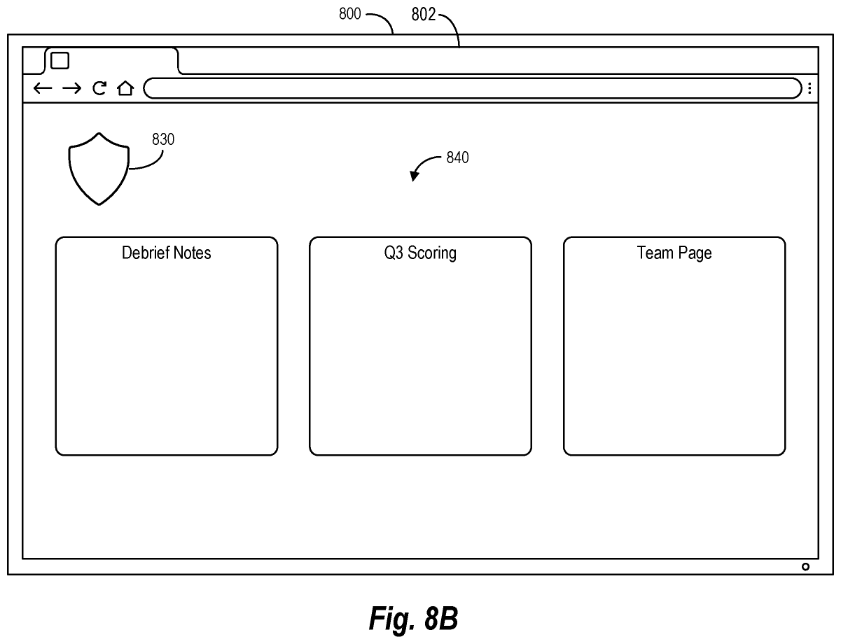

As discussed, in some implementations, the composite action system 102 provides a composite action to a client device. For instance, FIGS. 8A and 8B illustrate the composite action system 102 providing a composite action and a content stack for display via a user interface of the client device in accordance with one or more embodiments.

In particular, FIG. 8A shows the composite action system 102 providing a stack of composite actions 810 for display via a graphical user interface 802 of a client device 800. The stack of composite actions 810 includes a composite action 812 (e.g., as a top-ranked composite action within the stack). In some embodiments, the composite action system 102 provides an indication (e.g., a widget) of the composite action 812 for display via the client device 800. For example, the indication is selectable to access a set of content items relevant to a set of tasks within the composite action.

To illustrate, in some implementations, the composite action system 102 utilizes the large language model to analyze the composite action 812 (e.g., the hybridized combination of the set of tasks within the composite action 812) and generate a summary message comprising an explanation of the hybridized combination of the set of tasks. The composite action system 102 can include the summary message in the indication of the composite action 812.

Moreover, and as describe above, in some embodiments, the composite action system 102 determines a classification for the composite action 812. In some cases, if the classification indicates that the composite action 812 is a new composite action, the composite action system 102 provides relevant content items from the content management system for display via the client device 800. In some other cases, if the classification indicates that the composite action 812 is a continued composite action, the composite action system 102 generates a continuation summary based on previous tasks in the composite action 812 and provides the continuation summary for display via the client device (e.g., included with the indication of the composite action 812).

As shown in FIG. 8A, the composite action system 102 can provide various selection options to the user account in relation to the composite action 812. For example, the composite action system 102 provides a “Focus” option 822, a “Snooze” option 824, and an “Ignore” option 826. Upon selection, by the user account, of the “Focus” option 822, the composite action system 102 provides the composite action 812 for display with minimal (or reduced) other user interface elements to offer the user account a user interface with maximized (or increased) attention on the composite action 812. Alternatively, upon selection of the “Snooze” option 824, the composite action system 102 removes the composite action 812 from display and saves the composite action 812 for display at a later time (e.g., after a predetermined period of time, or after another composite action is completed). Moreover, upon selection of the “Ignore” option 826, the composite action system 102 removes the composite action 812 from display (e.g., permanently). In some implementations, the composite action system 102 trains the large language model 120 (e.g., by updating parameters of the large language model 120) based on the selection of the “Ignore” option 826. For example, the composite action system 102 provides feedback to the large language model 120 that the generated and suggested composite action 812 was identified by the user account as not needed at that time.

FIG. 8B shows the composite action system 102 providing a composite action for display via the graphical user interface 802 of the client device 800. In particular, FIG. 8B shows content items 840. For example, upon selection by the user account of the “Focus” option 822 for the composite action 812, the composite action system 102 provides for display an expanded window with increased attention to the composite action 812. The composite action system 102 presents the content items 840 (e.g., from the content stack provided with the indication for the composite action 812). Thus, the composite action system 102 offers the user account a focused view of the content items relevant to the current composite action.

In addition, FIG. 8B shows the composite action system 102 maintaining the composite action by utilizing a composite action shield 830 (e.g., similar to or the same as the composite action shield 610). Thus, as described above, the composite action system 102 can prevent notifications unrelated to the composite action from surfacing on the user interface 802. For example, the composite action system 102 provides the content items 840 for display via the user interface 802, while suppressing one or more user interface elements that are not associated with the composite action 812. Alternatively, if the composite action system 102 determines that a user interface element has a high priority level, the composite action system 102 can provide the high-priority user interface element for display via the user interface 802.

In some embodiments, the composite action system 102 can assist a user account by blocking out time on a calendar of the user account for a composite action. For example, the composite action system 102 generates a suggested calendar item for a task of the composite action and provides, via the client device 800, a selection option for the user account to accept, change, or reject the suggested calendar item. In some implementations, the composite action system 102 automatically inserts the suggested calendar item into a schedule (e.g., on the calendar) of the user account.

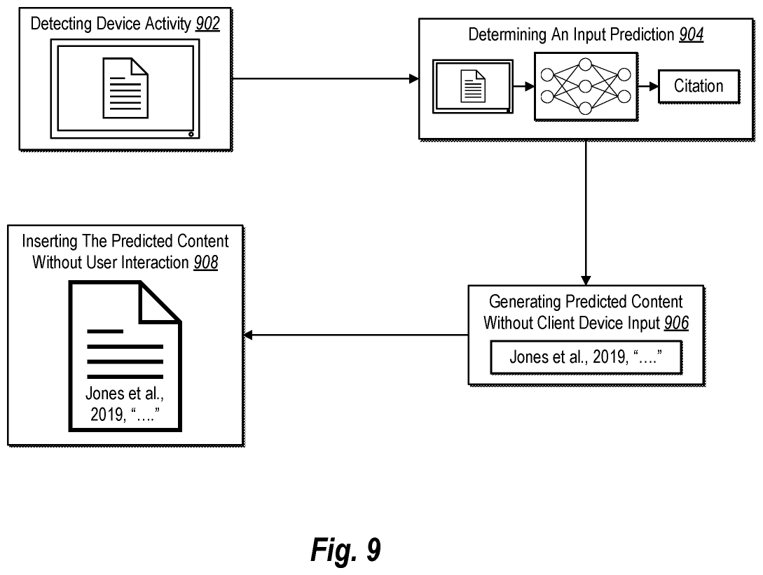

As discussed, in some embodiments, the composite action system 102 performs actions to automatically populate a content item with content for a user account. For instance, FIG. 9 illustrates the composite action system 102 generating predicted content and inserting the predicted content into a content item without user input in accordance with one or more embodiments.

To further illustrate, in some embodiments, the composite action system 102 performs an act 902 for detecting device activity. For instance, the composite action system 102 detects client device activity in relation to a content item associated with a user account of a content management system.

Upon detecting the device activity, in some implementations, the composite action system 102 performs an act 904 for determining an input prediction. For example, the composite action system 102 determines, based on the client device activity and an activity history associated with the user account, an input prediction defining one or more predicted client device inputs to be provided to the client device. For instance, the composite action system 102 analyzes data signals collected by connectors from software tools associated with the user account (e.g., as described in connection with FIG. 3) to determine the input prediction. To further illustrate, in some implementations, the composite action system 102 predicts a user account intent (e.g., for would-be subsequent user account actions) by analyzing activity history and/or other account-based signals (e.g., captured by connectors and stored in a knowledge graph) to determine a likely subsequent action of the user account. For instance, in some implementations, the composite action system 102 processes the client device activity and the activity history as a large language model prompt though a large language model to determine the input prediction.

Moreover, in some embodiments, the composite action system 102 performs an act 906 for generating predicted content without client device input. To illustrate, the composite action system 102 generates, based on the input prediction and without receiving client device input, predicted content to add to the content item in response to the one or more predicted client device inputs. For example, the composite action system 102 processes the input prediction and data signals collected by the connectors as a large language model prompt through a large language model, and utilizes the output of the large language model as the predicted content. In some cases, the composite action system 102 includes a request in the large language model prompt to summarize the initial outputs of the large language model. Thus, in some embodiments, the composite action system 102 utilizes a summary generated by the large language model as the predicted content.

As another example, in some embodiments, the composite action system 102 generates the predicted content by locating sample content from a repository and modifying the sample content based on the client device activity and the activity history. For instance, the composite action system 102 identifies sample content within another content item (e.g., within the content management system 104) and modifies the sample content based on the client device activity, the activity history, and/or the input prediction. The composite action system 102 can utilize the modified sample content as the predicted content.

Additionally, in some implementations, the composite action system 102 performs an act 908 for inserting the predicted content without user interaction. For instance, the composite action system 102 inserts the predicted content within the content item without user interaction prompting the predicted content. For example, the composite action system 102 automatically adds the predicted content to the content item and saves the content item as modified with the added predicted content.

To illustrate, in some cases, the composite action system 102 detects that the user account inserts a quotation into a document. Based on the insertion of the quotation, and based on account history of the user account, the composite action system 102 can predict that the user account will next (or later on) add a citation for the quotation. As an assist to the user account, the composite action system 102 can generate a predicted citation (e.g., by locating a source for the quotation) and insert the predicted citation into the document, thereby alleviating the user account of the need to look up the citation. In this way, the composite action system 102 provides added computing functionality over existing systems and assists the user account in maintaining focus on the composite action (e.g., rather than diverting from the composite action to look up the citation).

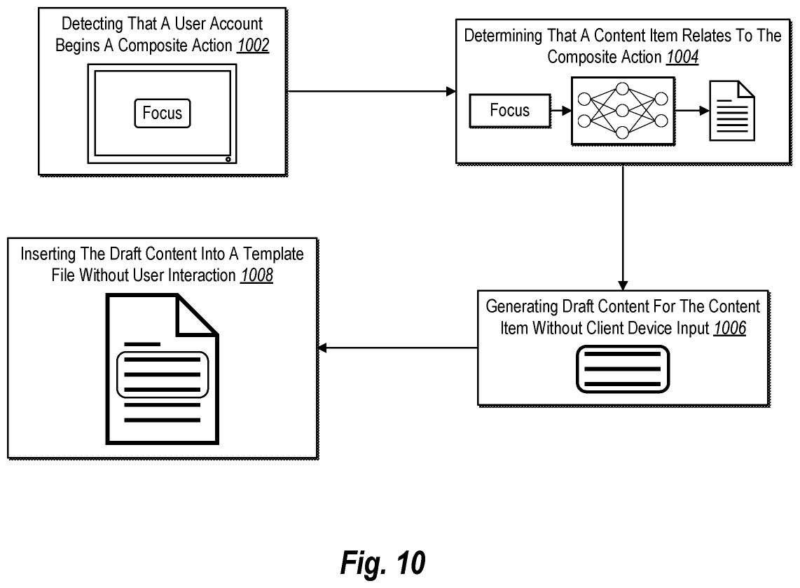

As discussed, in some implementations, the composite action system 102 performs actions to automatically generate a draft content item for a user account. For instance, FIG. 10 illustrates the composite action system 102 generating draft content and inserting the draft content into a template file without user input in accordance with one or more embodiments.

To further illustrate the acts of FIG. 10, and in connection with the similar acts shown in FIG. 9, in some embodiments, the composite action system 102 performs an act 1002 for detecting that a user account begins a composite action. For instance, the composite action system 102 detects client device activity in relation to a content item by detecting that the user account begins the composite action. Upon detecting that the user account begins the composite action, in some implementations, the composite action system 102 performs an act 1004 for determining that a content item relates to the composite action. For example, the composite action system 102 determines an input prediction by determining, based on the user account beginning the composite action, that the content item relates to the composite action. Moreover, in some embodiments, the composite action system 102 performs an act 1006 for generating draft content for the content item without client device input. To illustrate, the composite action system 102 generates predicted content to add to the content item by generating draft content for a first draft of the content item. Additionally, in some implementations, the composite action system 102 performs an act 1008 for inserting the draft content into a template file without user interaction. For instance, the composite action system 102 inserts the predicted content within the content item by inserting the draft content into the template file for the content item.

To illustrate, in some cases, the composite action system 102 detects that the user account begins a composite action that includes writing a report. Based on beginning the composite action, and based on user account history (e.g., prior instances of writing similar reports), the composite action system 102 can predict that the user account would otherwise create a new report (e.g., from scratch, from a template, etc.) and add content to the report. In some embodiments, the composite action system 102 generates draft content for the report and inserts the draft content into a template file. The composite action system 102 provides the template file (with the inserted draft content) as a first draft of the report to the user account. In this way, the composite action system 102 can save time for the user account, thereby helping to keep the user account focused on the composite action.

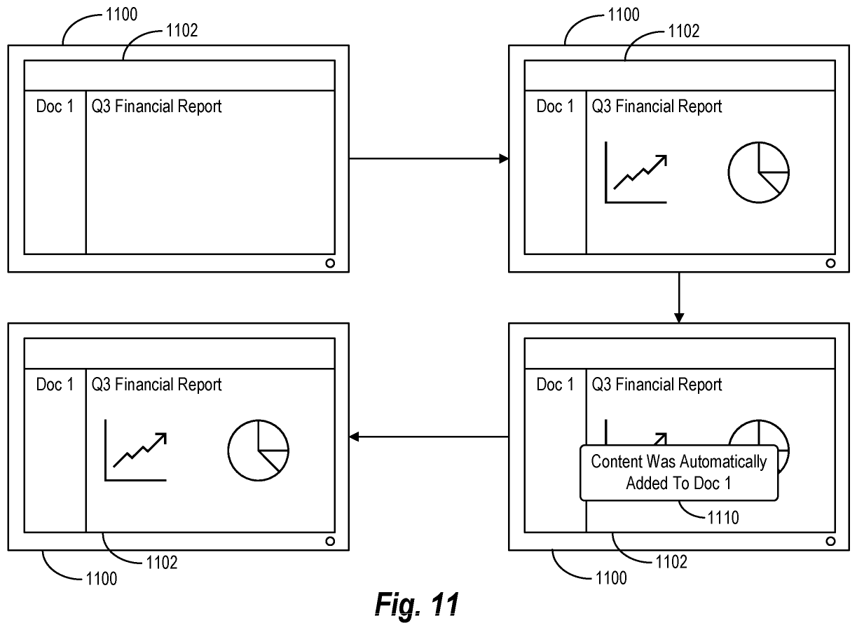

As discussed, in some embodiments, the composite action system 102 automatically populates a content item with content for a user account and notifies the user account. For instance, FIG. 11 illustrates the composite action system 102 providing a content item for display via a user interface of a client device, populating the content item with predicted content without user input, and notifying the user account of the added content in accordance with one or more embodiments.

Specifically, FIG. 11 shows the composite action system 102 providing a content item for display via a user interface 1102 of a client device 1100. As described in connection with FIG. 9, in some implementations, the composite action system 102 detects client device activity, determines an input prediction, generates predicted content, and automatically inserts the predicted content within the content item. FIG. 11 illustrates an example of the composite action system 102 detecting a user account working on a third quarter financial report. The composite action system 102 determines that financial data for the financial report will be added to the report. Without client device input (e.g., without the user account begging to retrieve the financial data), the composite action system 102 can generate predicted content (e.g., by retrieving the financial data from some source) to add to the report. Moreover, the composite action system 102 can insert the predicted content (e.g., the financial data) within the financial report without user interaction prompting the predicted content. In other words, the composite action system 102 can add the financial data to the financial report without the user account asking for or querying the client device 1100 for the financial data.

As shown in FIG. 11, in some embodiments, the composite action system 102 provides, for display via the user interface 1102 of the client device 1100, a notification 1110 indicating that the predicted content was added to the content item. For example, the composite action system 102 surfaces the notification 1110 to the client device 1100 upon inserting the financial data into the financial report. In some embodiments, the composite action system 102 provides the notification 1110 for a predetermined period of time (e.g., ten seconds) and then removes the notification 1110. In some implementations, the composite action system 102 provides a selection button to the client device 1100 for the user account to acknowledge the insertion of the additional content before the notification 1110 is removed.

In some embodiments, the composite action system 102 utilizes a composite action shield (as described above) while automatically inserting content into a content item. For example, while determining an input prediction, generating predicted content based on the input prediction, and/or inserting the predicted content into the content item, the composite action system 102 can receive one or more user interface elements associated with a different content item. Based on determining that the one or more user interface elements are unrelated to the content item, the composite action system 102 can suppress the one or more user interface elements from display via the user interface 1102 of the client device 1100.

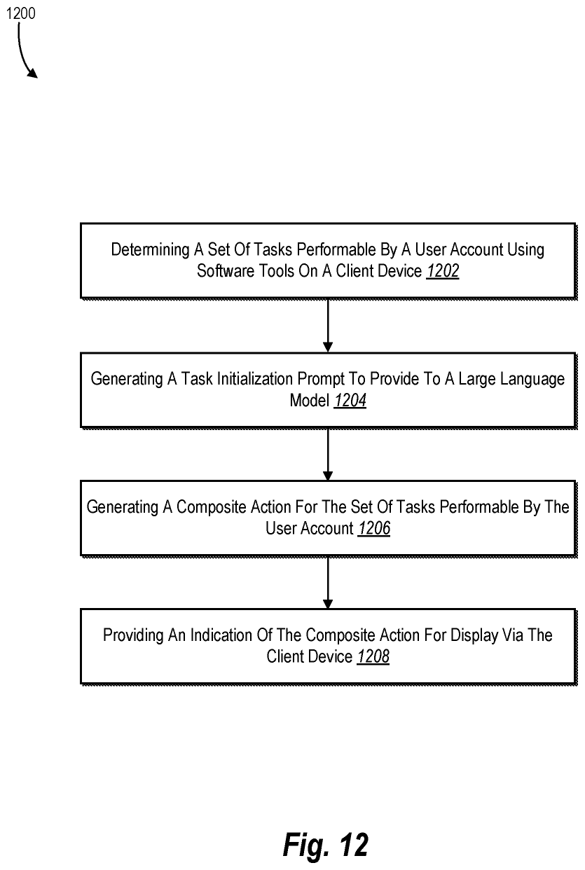

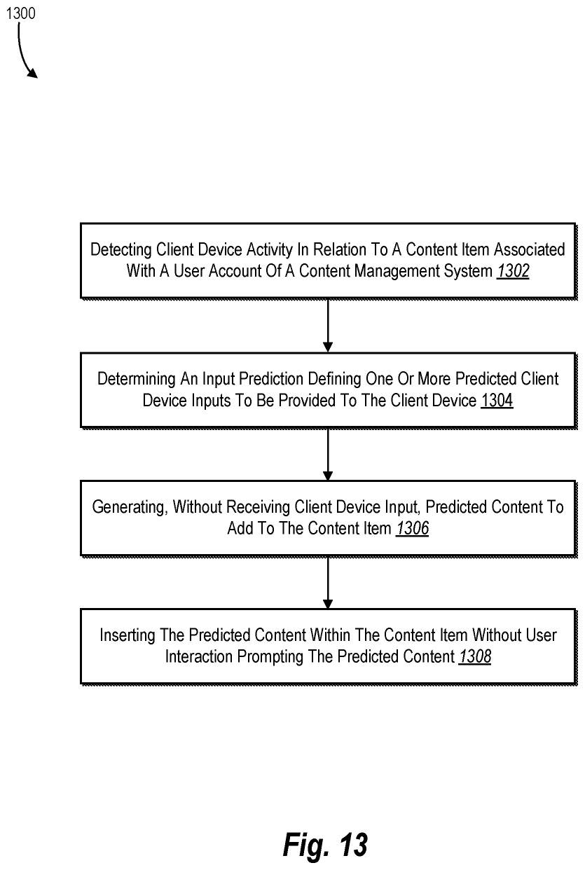

FIGS. 1-11, the corresponding text, and the examples provide a number of different methods, systems, devices, and non-transitory computer-readable media of the composite action system 102. In addition to the foregoing, one or more embodiments can also be described in terms of flowcharts comprising acts for accomplishing a particular result, as shown in FIGS. 12 and 13. FIGS. 12 and 13 may be performed with more or fewer acts. Further, the acts may be performed in differing orders. Additionally, the acts described herein may be repeated or performed in parallel with one another or parallel with different instances of the same or similar acts.

As mentioned, FIG. 12 illustrates a flowchart of a series of acts 1200 for generating and providing composite actions in accordance with one or more implementations. While FIG. 12 illustrates acts according to one implementation, alternative implementations may omit, add to, reorder, and/or modify any of the acts shown in FIG. 12. The acts of FIG. 12 can be performed as part of a method. Alternatively, a non-transitory computer-readable medium can comprise instructions that, when executed by one or more processors, cause a computing device to perform the acts of FIG. 12. In some implementations, a system performs the acts of FIG. 12.

As shown in FIG. 12, the series of acts 1200 includes an act 1202 of determining a set of tasks performable by a user account using software tools on a client device, an act 1204 of generating a task initialization prompt to provide to a large language model, an act 1206 of generating a composite action for the set of tasks performable by the user account, and an act 1208 of providing an indication of the composite action for display via the client device.

In particular, in some implementations, the act 1202 includes determining, utilizing connectors to collect data from software tools used by a user account of a content management system, a set of tasks performable by the user account using the software tools on a client device, the act 1204 includes generating, from the set of tasks performable by the user account, a task initialization prompt to provide to a large language model, the act 1206 includes generating, utilizing the large language model to process the task initialization prompt, a composite action comprising a hybridized combination of the set of tasks performable by the user account along with a set of content items relevant to the set of tasks, and the act 1208 includes providing an indication of the composite action for display via the client device, wherein the indication is selectable to access the set of content items relevant to the set of tasks. In some implementations, the act 1206 includes generating, utilizing the large language model to process the task initialization prompt, a composite action comprising a hybridized combination of the set of tasks performable by the user account, and the act 1208 includes providing, for display via the client device, an indication of the composite action that is selectable to access a set of content items relevant to the set of tasks. Moreover, in some implementations, the act 1206 includes generating, utilizing the large language model to process the task initialization prompt, a composite action for the set of tasks performable by the user account, and the act 1208 includes providing, for display via the client device, an indication of the composite action along with a set of content items relevant to the composite action.

For example, in some implementations, the series of acts 1200 includes utilizing the connectors to collect the data from the software tools used by the user account by collecting at least one of audio data from a videoconference recording associated with the user account, text data from written communications associated with the user account, schedule data from a calendar associated with the user account, or project data from a project management application associated with the user account. Additionally, in some implementations, the series of acts 1200 includes utilizing the connectors to collect the data from the software tools used by the user account by collecting at least one of audio data from a videoconference recording, text data from written communications, schedule data from a calendar, or project data from a project management application.

In addition, in some implementations, the series of acts 1200 includes generating the task initialization prompt to provide to the large language model by prioritizing the set of tasks performable by the user account by: determining, for each task within the set of tasks, a hierarchy of requesting user accounts of the content management system; determining due dates associated with each task within the set of tasks; determining, based on signals of a knowledge graph associated with the set of tasks, an importance metric for each task within the set of tasks; or determining a task creation date for each task within the set of tasks. Moreover, in some implementations, the series of acts 1200 includes generating the task initialization prompt to provide to the large language model further by comparing the set of tasks with related tasks performable by one or more additional user accounts of the content management system. Additionally, in some implementations, the series of acts 1200 includes generating the task initialization prompt to provide to the large language model by: comparing the set of tasks with related tasks performable by one or more additional user accounts of the content management system; and prioritizing the set of tasks performable by the user account utilizing one or more prioritization algorithms.

Furthermore, in some implementations, the series of acts 1200 includes generating the composite action by: determining account-based signals between the user account and additional user accounts of the content management system; generating a knowledge graph comprising: nodes representing the user account and the additional user accounts; and edges representing relationships between the user account and the additional user accounts; and identifying, based on edge lengths of the edges, clusters of prioritized tasks performable by the user account.

Additionally, in some implementations, the series of acts 1200 includes providing the indication of the composite action for display via the client device by: utilizing the large language model to analyze the hybridized combination of the set of tasks; and generating a summary message comprising an explanation of the hybridized combination of the set of tasks.

Moreover, in some implementations, the series of acts 1200 includes receiving a notification intended for the user account; determining a priority level for the notification; and based on determining that the priority level exceeds a predetermined threshold priority, providing the notification for display via the client device. In addition, in some implementations, the series of acts 1200 includes receiving a user interface element intended for the user account; determining a priority level for the user interface element; and based on determining that the priority level exceeds a predetermined threshold priority, providing the user interface element for display via the client device. Furthermore, in some implementations, the series of acts 1200 includes determining that a user interface element has a high priority level; and providing the user interface element for display via the client device. In addition, in some implementations, the series of acts 1200 includes providing, for display via the client device, the set of content items relevant to the set of tasks; and suppressing at least one user interface element associated with a different composite action.

Additionally, in some implementations, the series of acts 1200 includes generating the composite action by: generating an index mapped from a knowledge graph of user accounts and content items of the content management system; and determining the content items relevant to the set of tasks based on relationships, shown in the index, between the set of tasks and a plurality of content items within the content management system. Moreover, in some implementations, the series of acts 1200 includes generating the composite action by: generating a knowledge graph of user accounts and content items of the content management system; and generating the composite action for the set of tasks based on relationships, represented in the knowledge graph, between the set of tasks and a plurality of content items within the content management system.

Additionally, in some implementations, the series of acts 1200 includes determining a classification for the composite action; if the classification indicates that the composite action is a new composite action, providing relevant content items from the content management system for display via the client device; and if the classification indicates that the composite action is a continued composite action, generating a continuation summary based on previous tasks in the composite action and providing the continuation summary for display via the client device. Moreover, in some implementations, the series of acts 1200 includes determining a classification for the composite action; if the classification indicates that the composite action is a new composite action, providing relevant content items from the content management system for display via the client device; and if the classification indicates that the composite action is a continued composite action, providing a continuation summary of previous tasks in the composite action for display via the client device.

Furthermore, in some implementations, the series of acts 1200 includes determining that a composite action is complete; generating, for additional user accounts of the content management system, an update notification indicating a completion status for the composite action; and providing a selection option to the user account to publish the update notification to one or more client devices of the additional user accounts.

In addition, in some implementations, the series of acts 1200 includes generating a suggested calendar item for a task of the composite action; and providing, via the client device, a selection option for the user account to accept, change, or reject the suggested calendar item.

As mentioned, FIG. 13 illustrates a flowchart of a series of acts 1300 for generating predicted content without client device input and inserting the predicted content within a content item without user interaction in accordance with one or more implementations. While FIG. 13 illustrates acts according to one implementation, alternative implementations may omit, add to, reorder, and/or modify any of the acts shown in FIG. 13. The acts of FIG. 13 can be performed as part of a method. Alternatively, a non-transitory computer-readable medium can comprise instructions that, when executed by one or more processors, cause a computing device to perform the acts of FIG. 13. In some implementations, a system performs the acts of FIG. 13.

As shown in FIG. 13, the series of acts 1300 includes an act 1302 of detecting client device activity in relation to a content item associated with a user account of a content management system, an act 1304 of determining an input prediction defining one or more predicted client device inputs to be provided to the client device, an act 1306 of generating, without receiving client device input, predicted content to add to the content item, and an act 1308 of inserting the predicted content within the content item without user interaction prompting the predicted content.

In particular, in some implementations, the act 1302 includes detecting client device activity in relation to a content item associated with a user account of a content management system, the act 1304 includes determining, based on the client device activity and an activity history associated with the user account, an input prediction defining one or more predicted client device inputs to be provided to a client device, the act 1306 includes generating, based on the input prediction and without receiving client device input, predicted content to add to the content item in response to the one or more predicted client device inputs, and the act 1308 includes inserting the predicted content within the content item without user interaction prompting the predicted content. In some implementations, the act 1306 includes generating, based on the input prediction and without receiving client device input, predicted content to add to the content item. In some implementations, the act 1308 includes automatically inserting the predicted content within the content item without user interaction prompting the predicted content.

For example, in some implementations, the series of acts 1300 includes determining the input prediction defining the one or more predicted client device inputs by analyzing data signals collected by connectors from software tools associated with the user account. Moreover, in some implementations, the series of acts 1300 includes generating the predicted content to add to the content item in response to the one or more predicted client device inputs by processing the data signals collected by the connectors as a prompt through a large language model. Additionally, in some implementations, the series of acts 1300 includes generating the predicted content to add to the content item by processing, as a prompt through a large language model, data signals collected by connectors from software tools associated with the user account. Furthermore, in some implementations, the series of acts 1300 includes determining the input prediction defining the one or more predicted client device inputs by analyzing data signals collected by connectors from software tools associated with the user account; and generating the predicted content to add to the content item in response to the one or more predicted client device inputs by processing the data signals collected by the connectors as a prompt through a large language model.

In addition, in some implementations, the series of acts 1300 includes generating the predicted content to add to the content item in response to the one or more predicted client device inputs by locating sample content from a repository and modifying the sample content based on the client device activity and the activity history. Moreover, in some implementations, the series of acts 1300 includes generating the predicted content to add to the content item in response to the one or more predicted client device inputs by identifying sample content within another content item and modifying the sample content based on the client device activity and the activity history.

Furthermore, in some implementations, the series of acts 1300 includes inserting the predicted content within the content item without user interaction prompting the predicted content by: automatically adding the predicted content to the content item; saving the content item as modified with the added predicted content; and providing, for display via a user interface of the client device, a notification that the predicted content was added to the content item. Moreover, in some implementations, the series of acts 1300 includes inserting the predicted content within the content item without user interaction prompting the predicted content by: adding the predicted content to the content item; saving the content item as modified with the predicted content; and providing, for display via the client device, a notification that the predicted content was inserted within the content item.

Additionally, in some implementations, the series of acts 1300 includes detecting the client device activity in relation to the content item by detecting that the user account begins a composite action; determining the input prediction by determining, based on the user account beginning the composite action, that the content item relates to the composite action; generating the predicted content to add to the content item by generating draft content for a first draft of the content item; and inserting the predicted content within the content item by inserting the draft content into a template file for the content item. Moreover, in some implementations, the series of acts 1300 includes detecting the client device activity in relation to the content item by detecting that the user account begins a composite action; determining the input prediction by determining, based on the user account beginning the composite action, that the content item relates to the composite action; generating the predicted content to add to the content item by generating draft content for an initial draft of the content item; and inserting the predicted content within the content item by inserting the draft content for the initial draft into a template file for the content item.

Furthermore, in some implementations, the series of acts 1300 includes detecting the client device activity in relation to the content item by detecting that the user account begins a composite action; determining the input prediction by determining, based on the user account beginning the composite action, that the content item relates to the composite action; generating the predicted content to add to the content item by generating draft content for a first draft of the content item; and automatically inserting the predicted content within the content item comprises automatically by the draft content into a template file for the content item. Additionally, in some implementations, the series of acts 1300 includes providing the template file with the draft content for the first draft of the content item for display via a user interface of the client device.

Moreover, in some implementations, the series of acts 1300 includes providing, for display via the client device, the content item comprising the predicted content; receiving at least one user interface element associated with a different content item; and based on determining that the at least one user interface element is unrelated to the content item, suppressing the at least one user interface element from display via the client device. In addition, in some implementations, the series of acts 1300 includes determining that a composite action of the user account is paused or complete; and generating a summary content item comprising a summary of the at least one user interface element. Additionally, in some implementations, the series of acts 1300 includes receiving one or more user interface elements associated with a different content item; based on determining that the one or more user interface elements are unrelated to the content item, suppressing the one or more user interface elements from display via the client device; and generating a summary content item comprising a summary of the one or more user interface elements.

Furthermore, in some implementations, the series of acts 1300 includes determining that a composite action of the user account is paused or complete; generating, for additional user accounts of the content management system, an update notification indicating a completion status for the composite action; and providing, without additional interaction by the user account, the update notification to the additional user accounts for display via user interfaces of client devices associated with the additional user accounts. In addition, in some implementations, the series of acts 1300 includes determining that a composite action of the user account is paused or complete; generating, for one or more additional user accounts of the content management system, an update notification indicating a status of the composite action; and providing, without additional interaction by the user account, the update notification to the one or more additional user accounts for display via client devices associated with the one or more additional user accounts.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 14 illustrates a block diagram of an example computing device 1400 that may be configured to perform one or more of the processes described above. One will appreciate that one or more computing devices, such as the computing device 1400, may represent the computing devices described above (e.g., the server device(s) 106, the client device 108). In one or more embodiments, the computing device 1400 may be a mobile device (e.g., a mobile telephone, a smartphone, a PDA, a tablet, a laptop, a camera, a tracker, a watch, a wearable device, etc.). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 includes hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes the memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes the storage device 1406 for storing data or instructions. As an example, and not by way of limitation, the storage device 1406 can include a non-transitory storage medium described above. The storage device 1406 may include a hard disk drive (“HDD”), flash memory, a Universal Serial Bus (“USB”) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (“NIC”) or network adapter for communicating with an Ethernet or other wire-based network or a wireless NIC (“WNIC”) or wireless adapter for communicating with a wireless network, such as a WI-FI. The computing device 1400 can further include the bus 1412. The bus 1412 can include hardware, software, or both that connects components of computing device 1400 to each other.

The components of the composite action system 102 can include software, hardware, or both. For example, the components of the composite action system 102 can include one or more instructions stored on a computer-readable storage medium and executable by processors of one or more computing devices, such as a client device or server device. When executed by the one or more processors, the computer-executable instructions of the composite action system 102 can cause the computing device(s) to perform the methods described herein. Alternatively, the components of the composite action system 102 can include hardware, such as a special purpose processing device to perform a certain function or group of functions. Alternatively, the components of the composite action system 102 can include a combination of computer-executable instructions and hardware.

Furthermore, the components of the composite action system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the composite action system 102 may be implemented as a stand-alone application, such as a desktop or mobile application. Furthermore, the components of the composite action system 102 may be implemented as one or more web-based applications hosted on a remote server. The components of the composite action system 102 may also be implemented in a suite of mobile device applications or “apps.”

FIG. 15 is a schematic diagram illustrating a network environment 1500 within which one or more implementations of the composite action system 102 can be implemented. For example, the composite action system 102 may be part of a content management system 1502 (e.g., the content management system 104). The content management system 1502 may generate, store, manage, receive, and send digital content (such as digital content items). For example, the content management system 1502 may send and receive digital content to and from client device(s) 1506 by way of a network 1504. In particular, the content management system 1502 can store and manage a collection of digital content. The content management system 1502 can manage the sharing of digital content between computing devices associated with a plurality of users. For instance, the content management system 1502 can facilitate a user sharing digital content with another user of the content management system 1502.

In particular, the content management system 1502 can manage synchronizing digital content across multiple client devices 1506 associated with one or more users. For example, a user may edit digital content using client device 1506. The content management system 1502 can cause client device 1506 to send the edited digital content to the content management system 1502. The content management system 1502 then synchronizes the edited digital content on one or more additional computing devices.

In addition to synchronizing digital content across multiple devices, one or more implementations of the content management system 1502 can provide an efficient storage option for users that have large collections of digital content. For example, the content management system 1502 can store a collection of digital content on the content management system 1502, while the client device 1506 only stores reduced-sized versions of the digital content. A user can navigate and browse the reduced-sized versions (e.g., a thumbnail of a digital image) of the digital content on the client device 1506. In particular, one way in which a user can experience digital content is to browse the reduced-sized versions of the digital content on the client device 1506.

Another way in which a user can experience digital content is to select a reduced-size version of digital content to request the full- or high-resolution version of digital content from the content management system 1502. In particular, upon a user selecting a reduced-sized version of digital content, the client device 1506 sends a request to the content management system 1502 requesting the digital content associated with the reduced-sized version of the digital content. The content management system 1502 can respond to the request by sending the digital content to the client device 1506. The client device 1506, upon receiving the digital content, can then present the digital content to the user. In this way, a user can have access to large collections of digital content while minimizing the amount of resources used on the client device 1506.

The client device 1506 may be a desktop computer, a laptop computer, a tablet computer, a personal digital assistant (PDA), an in- or out-of-car navigation system, a smart TV, a virtual reality (VR) or augmented reality (AR) device, a handheld device, a wearable device, a smartphone or other cellular or mobile phone, or a mobile gaming device, other mobile device, or other suitable computing devices. The client device 1506 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.) to access and view content over the network 1504.

The network 1504 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the client device(s) 1506 may access the content management system 1502.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting client device activity in relation to a content item associated with a user account of a content management system;
determining, based on the client device activity and an activity history associated with the user account, an input prediction defining one or more predicted client device inputs to be provided to a client device;
generating, based on the input prediction and without receiving client device input, predicted content to add to the content item in response to the one or more predicted client device inputs; and
inserting the predicted content within the content item without user interaction prompting the predicted content.

2. The computer-implemented method of claim 1, wherein determining the input prediction defining the one or more predicted client device inputs comprises analyzing data signals collected by connectors from software tools associated with the user account.

3. The computer-implemented method of claim 2, wherein generating the predicted content to add to the content item in response to the one or more predicted client device inputs comprises processing the data signals collected by the connectors as a prompt through a large language model.

4. The computer-implemented method of claim 1, wherein generating the predicted content to add to the content item in response to the one or more predicted client device inputs comprises locating sample content from a repository and modifying the sample content based on the client device activity and the activity history.

5. The computer-implemented method of claim 1, wherein inserting the predicted content within the content item without user interaction prompting the predicted content comprises:
automatically adding the predicted content to the content item;
saving the content item as modified with the added predicted content; and
providing, for display via a user interface of the client device, a notification that the predicted content was added to the content item.

6. The computer-implemented method of claim 1, wherein:
detecting the client device activity in relation to the content item comprises detecting that the user account begins a composite action;
determining the input prediction comprises determining, based on the user account beginning the composite action, that the content item relates to the composite action;
generating the predicted content to add to the content item comprises generating draft content for a first draft of the content item; and
inserting the predicted content within the content item comprises inserting the draft content into a template file for the content item.

7. The computer-implemented method of claim 1, further comprising:
providing, for display via the client device, the content item comprising the predicted content;
receiving at least one user interface element associated with a different content item; and
based on determining that the at least one user interface element is unrelated to the content item, suppressing the at least one user interface element from display via the client device.

8. The computer-implemented method of claim 7, further comprising:
determining that a composite action of the user account is paused or complete; and
generating a summary content item comprising a summary of the at least one user interface element.

9. The computer-implemented method of claim 1, further comprising:
determining that a composite action of the user account is paused or complete;
generating, for additional user accounts of the content management system, an update notification indicating a completion status for the composite action; and
providing, without additional interaction by the user account, the update notification to the additional user accounts for display via user interfaces of client devices associated with the additional user accounts.

10. A system comprising:
at least one processor; and
at least one non-transitory computer-readable storage medium comprising instructions that, when executed by the at least one processor, cause the system to:
detect client device activity in relation to a content item associated with a user account of a content management system;
determine, based on the client device activity and an activity history associated with the user account, an input prediction defining one or more predicted client device inputs to be provided to a client device;
generate, based on the input prediction and without receiving client device input, predicted content to add to the content item; and
insert the predicted content within the content item without user interaction prompting the predicted content.

11. The system of claim 10, wherein generating the predicted content to add to the content item comprises processing, as a prompt through a large language model, data signals collected by connectors from software tools associated with the user account.

12. The system of claim 10, wherein inserting the predicted content within the content item without user interaction prompting the predicted content comprises:
adding the predicted content to the content item;
saving the content item as modified with the predicted content; and
providing, for display via the client device, a notification that the predicted content was inserted within the content item.

13. The system of claim 10, wherein:
detecting the client device activity in relation to the content item comprises detecting that the user account begins a composite action;
determining the input prediction comprises determining, based on the user account beginning the composite action, that the content item relates to the composite action;
generating the predicted content to add to the content item comprises generating draft content for an initial draft of the content item; and
inserting the predicted content within the content item comprises inserting the draft content for the initial draft into a template file for the content item.

14. The system of claim 10, wherein the instructions, when executed by the at least one processor, further cause the system to:
receive one or more user interface elements associated with a different content item;
based on determining that the one or more user interface elements are unrelated to the content item, suppress the one or more user interface elements from display via the client device; and
generate a summary content item comprising a summary of the one or more user interface elements.

15. The system of claim 10, wherein the instructions, when executed by the at least one processor, further cause the system to:
determine that a composite action of the user account is paused or complete;
generate, for one or more additional user accounts of the content management system, an update notification indicating a status of the composite action; and
provide, without additional interaction by the user account, the update notification to the one or more additional user accounts for display via client devices associated with the one or more additional user accounts.

16. A non-transitory computer-readable storage medium comprising instructions that, when executed by at least one processor, cause a computing device to:
detect client device activity in relation to a content item associated with a user account of a content management system;
determine, based on the client device activity and an activity history associated with the user account, an input prediction defining one or more predicted client device inputs to be provided to a client device;
generate, based on the input prediction and without receiving client device input, predicted content to add to the content item in response to the one or more predicted client device inputs; and
automatically insert the predicted content within the content item without user interaction prompting the predicted content.

17. The non-transitory computer-readable storage medium of claim 16, wherein:
determining the input prediction defining the one or more predicted client device inputs comprises analyzing data signals collected by connectors from software tools associated with the user account; and
generating the predicted content to add to the content item in response to the one or more predicted client device inputs comprises processing the data signals collected by the connectors as a prompt through a large language model.

18. The non-transitory computer-readable storage medium of claim 16, wherein generating the predicted content to add to the content item in response to the one or more predicted client device inputs comprises identifying sample content within another content item and modifying the sample content based on the client device activity and the activity history.

19. The non-transitory computer-readable storage medium of claim 16, wherein:
detecting the client device activity in relation to the content item comprises detecting that the user account begins a composite action;
determining the input prediction comprises determining, based on the user account beginning the composite action, that the content item relates to the composite action;
generating the predicted content to add to the content item comprises generating draft content for a first draft of the content item; and
automatically inserting the predicted content within the content item comprises automatically inserting the draft content into a template file for the content item.

20. The non-transitory computer-readable storage medium of claim 19, wherein the instructions, when executed by the at least one processor, further cause the computing device to provide the template file with the draft content for the first draft of the content item for display via a user interface of the client device.
